(19) United States
(12) Patent Application Publication
(10) Pub. No.: US 2024/0326519 A1
(43) Pub. Date: Oct. 3, 2024

(54) Method for monitoring the wear of a motor vehicle tire and tire pressure monitoring module for implementing said method

(71) Applicant: Continental Automotive Technologies GmbH, Hannover (DE)

(72) Inventors: Nicolas GUINART, Toulouse (FR); Jean-Philippe BOISSET, Montauban (FR)

(21) Appl. No.: 18/614,950

(22) Filed: Mar. 25, 2024

(30) Foreign Application Priority Data
Mar. 28, 2023 (FR) 2302954

(51) Int. Cl. B60C 11/24; B60C 23/04

(52) U.S. Cl. CPC B60C 11/246; B60C 23/0488

(57) ABSTRACT

The invention relates to a method for monitoring the wear of a motor vehicle tire. According to the invention, the method comprises the following steps of:
acquiring (step E1), from a tangential acceleration signal of said monitoring module, measurements of a variable in the group comprising a maximum tangential acceleration peak and a minimum tangential acceleration peak,
performing (step E2) processing of said measurements of said acquired variable,
comparing (step E3) said processed measurements to a predetermined maximum variation threshold value,
transmitting a warning (step E4) when said predetermined maximum variation threshold value is reached.

The invention also relates to a tire pressure monitoring module for implementing said method.

### CROSS REFERENCE TO RELATED APPLICATIONS

This application claims priority to French Patent Application No. 2302954, filed Mar. 28, 2023, the contents of such application being incorporated by reference herein.

### FIELD OF THE INVENTION

The present invention relates to a method for monitoring the wear of a motor vehicle tire and a tire pressure monitoring module for implementing said method.

### BACKGROUND OF THE INVENTION

Conventionally, a tire comprises on its outer surface a zone referred to as the “tread”, corresponding to the outer surface of the tire that is in contact with the roadway.

The tread comprises a relief, also called the “tread pattern”, making it possible in particular to discharge rainwater, snow, dust, heat, etc., in order to limit loss of grip of the tire or prevent aquaplaning.

Over the course of the kilometers traveled by the vehicle, the tread of the tire wears and becomes smooth, which increases the risk of loss of grip. Beyond a certain wear, it is therefore necessary to replace the worn tire with a new tire.

In order to detect the wear of a tire, it is known practice to use methods for monitoring the state of wear of the tire.

A first type of method, referred to as “direct methods”, makes it possible to deduce the deterioration of the tire through the use of a device that wears at the same time as the tire.

These methods can be manual, by means of a colored wear strip incorporated into the tread. This solution is however unsatisfactory in that the owner of the vehicle must visually inspect their tire in order to determine whether it should be replaced. They must also remember to inspect their tires themselves. A person with average attention does not systematically inspect their tires and after a certain amount of time, there is a risk that they will travel in a vehicle fitted with worn tires with only little grip, which poses an obvious hazard.

There is also a growing need for autonomous monitoring of the wear of a tire, in particular in the context of vehicle fleet management, which model forms part of the growing development of new modes of mobility in which the driver is not the owner and in which tracking and maintenance are carried out by specific organizations on large groups of vehicles. Autonomous monitoring of the wear of a tire also applies to an even greater extent to autonomous vehicles.

The autonomous methods for monitoring tire wear also include direct methods that make it possible to deduce the deterioration of the tire and are implemented in particular by measuring variations in impedance of tubes that pass through the tire.

A second type of method, referred to as “indirect methods”, makes it possible to deduce a state of wear of the tire by using data originating from one or more parameters of the wheel or of the motor vehicle.

The indirect methods of automatic monitoring of tire wear include a method known as tread depth monitoring, or TDM.

This method mainly uses signals originating from systems on board the motor vehicle to deduce the state of wear of the tires.

These onboard systems comprise in particular:

a global positioning system, or GPS, which makes it possible to acquire the speed of the motor vehicle,

a wheel speed sensor, or WSS, which makes it possible to acquire the rotation speed of the wheels of the motor vehicle,

a tire pressure monitoring system, or TPMS, which makes it possible to acquire the tire pressure.

The indirect methods for automatically monitoring tire wear also include a method known as tread depth sensing, or TDS, which aims to more directly use a signal that is perceived by the TPMS module and through which the state of wear of the tires is almost exclusively taken from this signal.

Unlike the aforementioned TDM method, in which a set of information acquired by different sensors of the motor vehicle is compiled, the TDS method is applied as close as possible to the source of the parameter to be monitored, which makes it possible to reduce the cause and effect chain used to deduce a state of wear of the tires of the motor vehicle.

Using the TDS method, the cause and effect chain is thus much shorter and thus more precise than the chain obtained using the TDM method.

A TDS method known from the prior art consists in using the tangential acceleration signal in the contact zone between the tire and the ground, to deduce a state of wear of the tire therefrom.

This signal corresponds to the tangential acceleration signal perceived by the TPMS module that is mounted in the tire and fixed on the tread of the tire.

The tangential accelerometer of the TPMS module monitors the tangential acceleration on rotation of the wheel on which the tire to be monitored is mounted.

Currently, the data acquired by the TPMS module is transmitted by radiofrequency to a central processing unit comprising an electronic control unit, or ECU.

Using the data acquired, the electronic control unit will develop a transfer function in order to determine, from the tangential acceleration signal acquired, a thickness of the tire.

The communication between the TPMS module and the processor of the central unit is relatively complicated to implement.

The communication between the TPMS module that acquires the data and the processor of the central unit that processes the data requires a phase of twinning the TPMS module and the processor of the central unit.

A communication strategy between the TPMS module and the processor of the central unit must therefore be specifically developed to allow this communication.

In addition, a solution for migrating the architecture allowing direct processing in the TPMS module would not be obvious to implement as some data is only accessible by the central processor and not by the TPMS module.

### SUMMARY OF THE INVENTION

An aspect of the present invention aims to overcome the drawbacks of the prior art, and to this end relates to a method for monitoring the wear of a motor vehicle tire, implemented by a tire pressure monitoring module mounted in said tire to be monitored, said module comprising a pressure sensor and a tangential accelerometer,

said method being notable in that it comprises the following steps of:

acquiring (step E1), from a tangential acceleration signal of said tire pressure monitoring module, measurements of at least one variable in the group comprising a maximum tangential acceleration peak and a minimum tangential acceleration peak,

performing (step E2) processing of said measurements of said at least one acquired variable,

comparing (step E3) said processed measurements to a predetermined maximum variation threshold value,

transmitting a warning (step E4) when said predetermined maximum variation threshold value is reached.

An aspect of the present invention provides a solution for monitoring the wear of the tire carried out solely by the tire pressure monitoring module mounted in the tire to be monitored, which makes it possible to make said solution autonomous and easily operational.

No particular system integration is then necessary. Implementing the method according to an aspect of the invention by means of a tire pressure monitoring module mounted in the tire to be monitored avoids having to transmit information to the central processor of the central processing unit of the motor vehicle, which in particular has a direct influence on the power consumption and service life of the monitoring module.

The information can also be used more directly compared to the prior art, and therefore more efficiently. The tire pressure monitoring module thus gives more refined information, which makes it possible to increase the relevance of the development of a wear processing strategy.

The monitoring method according to an aspect of the invention makes it possible to monitor and process the tangential acceleration signal of the tire pressure monitoring module, making it possible to deduce a significant wear level therefrom, which will make it possible to transmit a warning if applicable.

Unlike in the solutions known from the prior art, a transfer function is not used to determine, from the tangential acceleration signal acquired, a consumed thickness of the tread of the tire.

According to optional features of the method according to an aspect of the invention:

said acquisition step (step E1) comprises a sub-step (step E11) of learning initial conditions aiming to determine a reference value V_{ref} of said at least one variable V;

said reference value V_{ref} of said at least one variable V is equal to the mean of the values of said at least one variable V measured over a predetermined number of kilometers traveled by the monitored tire;

said acquisition step (step E1) comprises a sub-step (step E12) subsequent to said sub-step (step E11) of learning initial conditions and comprising the acquisition of measurements of instantaneous variables V(t) or the acquisition of a mean value V_{filt}(t) equal to the mean of the values of consecutive measurements of said at least one variable V over a predetermined number of kilometers traveled by the monitored tire;

said step (step E2) of processing said measurements of said at least one variable V acquired during the acquisition step (step E1) is carried out by applying an identity function on the basis of which a value is calculated that is equal to the difference, as an absolute value, between one of said instantaneous variables V(t) and said reference value V_{ref}, or the difference, as an absolute value, between said mean value V_{filt}(t) and said reference value V_{ref};

the method comprises a step (step E5) aiming to predict the distance remaining before a predetermined wear level of the monitored tire is reached;

said step (step E5) aiming to predict the distance remaining before a predetermined wear level of the monitored tire is reached is implemented following the warning transmission step (step E4);

said step (step E5) aiming to predict the distance remaining before a predetermined wear level of the monitored tire is reached is implemented before the warning transmission step (step E4) is reached;

said acquisition step (step E1) is carried out by periodically measuring said at least one variable V for an iteration i and for an iteration i-k, k>0, each of said iterations being carried out on a predetermined distance window;

said processing step (step E2) deduces, from the measurements acquired during the acquisition step (step E1), a mean value of said at least one variable V_{moy}_{ᵢ} monitored on iteration i, representing the mean of the measurements of said at least one variable V for an iteration i, and a mean value of said variable V_{moy}_{ᵢ₋ₖ}, k>0, representing the mean of the measurements of said at least one variable V for an iteration i-k;

said processing step (step E2) is carried out by applying a derivative function on the basis of which a derivative value of the mean values of said at least one variable V is calculated that is equal to the difference, as an absolute value, between the derivative relative to time of the mean value of said at least one variable V_{moy}_{ᵢ} on iteration i and the derivative relative to time of the mean value of said at least one variable V_{moy}_{ᵢ₋ₖ} on iteration i-k, k>0;

said acquisition step (step E1) can be initiated after a predetermined number of kilometers has been traveled by said tire to be monitored;

according to one arrangement, said at least one variable V is a compensated value.

An aspect of the invention also relates to a tire pressure monitoring module, comprising hardware and/or software means for implementing the method according to an aspect of the invention, notable in that said hardware and/or software means are implemented in an integrated circuit.

### BRIEF DESCRIPTION OF THE DRAWINGS

Further features, aims and advantages of aspects of the invention will become apparent on reading the following detailed description, which will be more clearly understood with reference to the appended drawings, in which:

FIG. 1 is a schematic view of a tire of a motor vehicle wheel according to an aspect of the invention.

FIG. 2 shows a curve illustrating an example of a tangential acceleration signal Z of a module for monitoring the pressure of a tire to be monitored as a function of time t.

FIG. 3 shows a comparison of tangential acceleration signals of a first tire and a second tire.

FIG. 4 sets out the steps of the method for monitoring the wear of a motor vehicle tire according to an aspect of the invention.

FIG. 5 sets out the steps of the monitoring method according to a first embodiment of the invention.

FIG. 6 shows the implementation of one of the steps of the method according to the first embodiment of the invention.

FIG. 7 shows a variant of the first embodiment.

### DETAILED DESCRIPTION OF THE PREFERRED EMBODIMENTS

In the description hereinafter, elements with an identical structure or similar functions are denoted by the same reference sign.

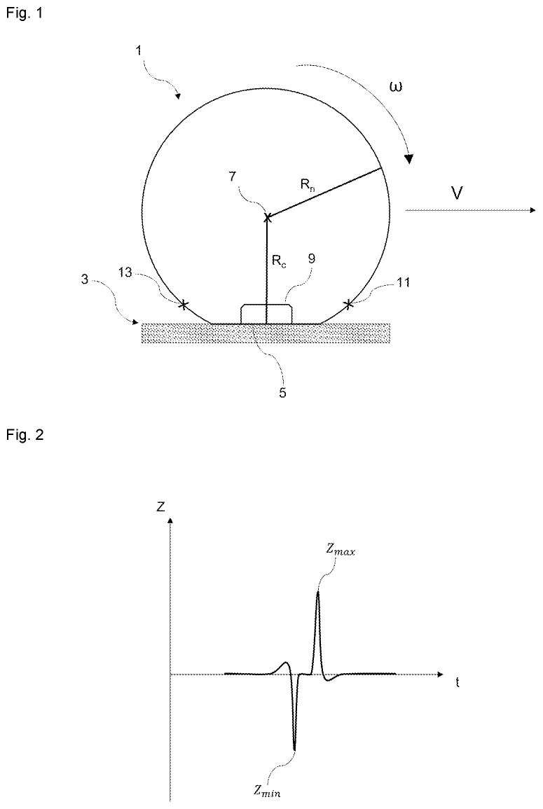

Reference is made to FIG. 1, which shows a tire 1 of a motor vehicle wheel according to an aspect of the invention.

The tire 1, mounted on a motor vehicle wheel (not shown) rests on the ground 3.

The tire 1 comprises a nominal radius Rₙ defined by the radius of the tire 1 when the wheel is unladen, that is, not mounted on the vehicle.

The laden tire 1 is deformed in the contact zone 5 between the tire 1 and the ground 3, on its tread.

In this contact zone, the radius of the tire 1 is defined by the laden radius R_{c}, which corresponds to the distance between the axis of rotation 7 of the wheel and the ground 3.

The tire 1 comprises a tire pressure monitoring system, or TPMS, module 9 according to an aspect of the invention, which makes it possible to acquire the tire pressure.

The TPMS module 9 according to an aspect of the invention comprises hardware and software means capable of implementing the method of an aspect of the invention. The software means comprise computer program code means, comprising in particular the algorithm implemented to execute the method of an aspect of the invention, while the hardware means comprise an electronic module comprising a tire pressure sensor and a tangential accelerometer capable of monitoring the tangential acceleration of the wheel.

In one embodiment of the invention, the hardware and/or software means for implementing the method according to an aspect of the invention can be implemented in an integrated circuit.

In the position of the wheel illustrated in FIG. 1, the TPMS module 9 is in contact with the ground 3.

FIG. 2 depicts the curve showing an example of a tangential acceleration signal Z perceived by the TPMS module 9 as a function of time t, for one complete rotation of the wheel on which the tire 1 is mounted.

Considering that the tire 1 rotates at a constant speed, the periodic signal representing the tangential acceleration curve therefore fluctuates around a zero value.

At the moment when the TPMS module 9 arrives almost in contact with the ground when the tire 1 is rotating in the direction of the arrow shown in FIG. 1, a pinching zone 11 of the tire 1 (visible in FIG. 1) is generated between the tire 1 and the ground 3.

This pinching zone 11 is reflected in a local reduction in the nominal radius Rₙ of the tire 1.

Given that the TPMS module 9 continues to rotate at the rotation speed ω, the local reduction in the nominal radius Rₙ of the tire 1 in the pinching zone 11 causes an increase in the tangential acceleration Z perceived by the TPMS module 9.

When the TPMS module 9 has passed through the pinching zone 11, the TPMS module 9 undergoes a strong deceleration as it goes from a positive speed to a zero speed when it arrives in the contact zone 5 with the ground 3.

This deceleration continues until it reaches a minimum tangential acceleration peak Zₘᵢₙ before returning, via a strong acceleration, to its zero value representing the tangential acceleration perceived by the TPMS module 9 in the contact zone 5 with the ground 3.

When the TPMS module 9 comes back out of the contact zone 5 with the ground 3 and resumes its rotational movement, the TPMS module 9 undergoes a strong acceleration that continues until it reaches a maximum tangential acceleration peak Zₘₐₓ before returning, via a strong deceleration, to its zero value representing the tangential acceleration perceived by the TPMS module 9 when the tire 1 continues its rotation at constant speed.

In the context of an aspect of the present invention and as will be seen hereinafter in the description, the method according to an aspect of the invention provides for the monitoring of changes in variables V in the group comprising at least the maximum tangential acceleration peak Zₘₐₓ and the minimum tangential acceleration peak Zₘᵢₙ.

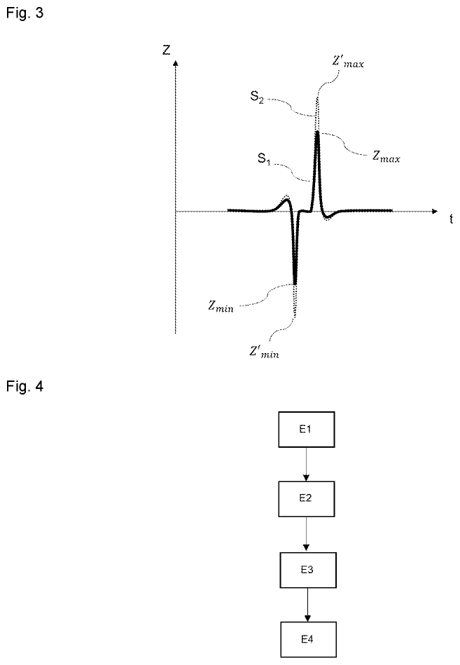

Reference is made to FIG. 3, which shows a comparison of a tangential acceleration signal S1 of a first tire, shown in bold, and a tangential acceleration signal S2 of a second tire, having greater wear than the first tire.

The tangential acceleration signal of the second tire has a maximum tangential acceleration peak Z′ₘₐₓ and a minimum tangential acceleration peak Z′ₘᵢₙ both respectively greater, as an absolute value, than the maximum tangential acceleration peak Zₘₐₓ of the first tire and the minimum tangential acceleration peak Zₘᵢₙ of the first tire.

As the second tire is thinner than the first tire due to its greater wear, the radius of curvature of the second tire in the pinching zones 11, 13 is smaller than that of the first tire.

It will be noted that other parameters can however influence the tangential acceleration signal. These parameters are, for example, the tire pressure, the load applied to the tire, and the speed of the vehicle.

In the context of an aspect of the present invention, the variables V that are used can be compensated values, that is, the values of the maximum tangential acceleration peak Zₘₐₓ, Z′ₘₐₓ and the values of the minimum tangential acceleration peak Zₘᵢₙ, Z′ₘᵢₙ only reflect the wear of the tire.

The method implemented to compensate the values of the maximum tangential acceleration peak Zₘₐₓ and the minimum tangential acceleration peak Zₘᵢₙ with the other parameters does not form part of an aspect of the present invention and is therefore not described in greater detail.

Reference is made to FIG. 4, which shows the steps of the method for monitoring the wear of a motor vehicle tire according to an aspect of the invention.

The monitoring method according to an aspect of the invention is implemented by the TPMS module 9 of the tire 1 and comprises the following steps of:

step E1: acquiring, from the tangential acceleration signal of the TPMS module, measurements of at least one variable in the group comprising a maximum tangential acceleration peak Zₘₐₓ and a minimum tangential acceleration peak Zₘᵢₙ,

step E2: performing processing of the measurements of said variables acquired during step E1,

step E3: comparing said processed measurements to a predetermined threshold value,

step E4: transmitting a warning when said predetermined threshold value is reached.

The method according to an aspect of the invention thus aims to monitor the changes in the tangential acceleration over time and transmit a warning signal when the monitored variables V exceed a certain threshold that corresponds to a maximum variation value.

More specifically, the method according to an aspect of the invention aims to monitor the changes in tangential acceleration over time and transmit a warning signal when a maximum tangential acceleration peak Zₘₐₓ or a minimum tangential acceleration peak Zₘᵢₙ exceeds a certain threshold, which corresponds to a maximum variation value for the maximum peak or for the minimum peak.

From the monitoring of the changes in tangential acceleration of the TPMS module 9, the monitoring method according to an aspect of the invention makes it possible to deduce a state of significant wear of the monitored tire.

An aspect of the present invention thus provides a solution for monitoring the wear of the tire carried out solely by the TPMS module 9 of the tire 1.

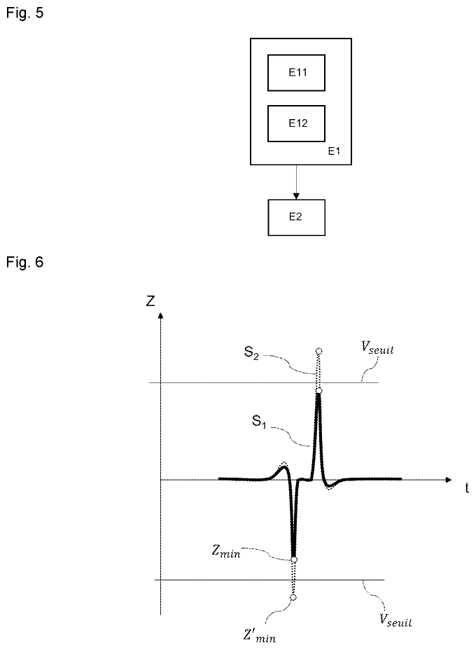

Reference is made to FIG. 5 to describe a first embodiment of the monitoring method of the invention.

The acquisition step E1 can comprise a first sub-step E11 of learning initial conditions.

The learning step E11 is typically initiated when the tire to be monitored is new.

The aim of the learning step E11 is to determine a reference value V_{ref} of the variable under consideration, which can be the maximum tangential acceleration peak Zₘₐₓ or the minimum tangential acceleration peak Zₘᵢₙ.

To this end, in the learning phase E11, the tangential acceleration signal of the TPMS module 9 of the tire 1 is monitored.

The reference value V_{ref} of the variable under consideration can be averaged over a predetermined number of kilometers of the life of the tire 1 to be monitored.

For example, the reference value V_{ref} of the variable under consideration can be equal to the mean of the values of the maximum tangential acceleration peak Zₘₐₓ or the mean of the values of the minimum tangential acceleration peak Zₘᵢₙ, for example measured over the first one thousand kilometers of the life of the tire 1.

The learning phase thus makes it possible to determine the value of the maximum tangential acceleration peak Zₘₐₓ or of the minimum tangential acceleration peak Zₘᵢₙ that the monitored tire is supposed to meet in a predetermined period, for example at the beginning of its life.

As a variant, the learning step E11 can be omitted and the reference value V_{ref} of the maximum tangential acceleration peak Zₘₐₓ or of the minimum tangential acceleration peak Zₘᵢₙ can be determined by any other means.

In particular, the reference value V_{ref} of the maximum tangential acceleration peak Zₘₐₓ or of the minimum tangential acceleration peak Zₘᵢₙ can be read from charts and entered into the algorithm for implementing the monitoring method of an aspect of the invention.

The acquisition step E1 then comprises a second sub-step E12 of acquiring measurements of the monitored variables V, initiated when the reference value V_{ref} has been fixed.

In a first embodiment, the sub-step E12 of acquiring measurements comprises the acquisition of measurements of instantaneous variables V(t) corresponding to the instantaneous value of the maximum tangential acceleration peak Zₘₐₓ or to the instantaneous value of the minimum tangential acceleration peak Zₘᵢₙ.

In a second embodiment, the sub-step E12 of acquiring measurements is carried out by finding the mean V_{filt}(t) of the consecutive measurements of the monitored variables V.

For example, a series of measurements of the monitored variables V is taken over a predetermined number of kilometers, and the mean of these measurements is found in order to deduce a mean value V_{filt}(t) of the monitored variable V.

The consecutive measurements with a view to calculating the mean thereof can be taken over a distance range, for example equal to around 50 kilometers.

The step E2 of processing the measurements of the variables V acquired during step E1 is for example carried out using a so-called “identity” function, which is an affine function of the changes in the variables V over time.

On the basis of this identity function, in step E2 the difference is calculated, as an absolute value, between the instantaneous variable V(t) and the reference value V_{ref}, or between the mean value V_{filt}(t) and the reference value V_{ref}.

Reference is made to FIG. 6, which sets out the execution of step E3 of the method according to an aspect of the invention.

The signal S1 shown in bold illustrates a tangential acceleration signal of a reference tire, and the signal S2 is a tangential acceleration signal of a tire being monitored.

During step E3, the value obtained during the processing step E2 is compared to a predetermined maximum variation threshold value Vₛₑᵤᵢₗ.

When the variable monitored is the maximum tangential acceleration peak Zₘₐₓ, the predetermined maximum variation threshold value Vₛₑᵤᵢₗ thus corresponds to a maximum threshold.

Likewise, when the variable monitored is the minimum tangential acceleration peak Zₘᵢₙ, the predetermined maximum variation threshold value Vₛₑᵤᵢₗ corresponds to a minimum threshold.

According to step E4 of the monitoring method of an aspect of the invention, if |V(t)−V_{ref}|>Vₛₑᵤᵢₗ, then a tire wear warning is generated.

Likewise, if |V_{filt}(t)−V_{ref}|>Vₛₑᵤᵢₗ, then a tire wear warning is generated (step E4).

In the illustration shown in FIG. 6, if the difference between the value of the minimum tangential acceleration peak Z′ₘᵢₙ of the signal S2 and the reference value V_{ref} of the variable under consideration (here equal to the value of the minimum tangential acceleration peak Zₘᵢₙ of the signal S1) is greater, as an absolute value, than the predetermined maximum variation threshold Vₛₑᵤᵢₗ, then a tire wear warning is generated (step E4).

The warning can be transmitted by radiofrequency, for example.

If the predetermined maximum variation threshold value Vₛₑᵤᵢₗ is exceeded, this means that the monitored variable V (Zₘₐₓ or Zₘᵢₙ) has increased as an absolute value relative to its reference value V_{ref}, and therefore that the tire is worn.

Given that the value of the monitored variable V being used is a compensated value that only reflects the wear of the tire, the other parameters that can influence its variation (in particular the tire pressure, the load applied to the tire, and the speed of the vehicle) do not affect the triggering of the steps of the method of an aspect of the invention, particularly the warning transmission step E4.

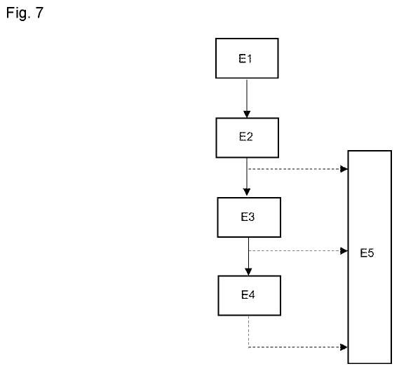

Reference is made to FIG. 7, which shows a variant of the first embodiment.

In this variant, a step E5 of predicting the distance remaining before a predetermined wear level of the monitored tire is reached can be initiated.

Step E5 can be implemented before the predetermined maximum variation threshold value Vₛₑᵤᵢₗ is reached, that is, at any time after step E2 of processing the measurements of the variables V acquired during step E1 is complete, and before the warning transmission step E4 is initiated. A message to the central processing unit is then regularly transmitted without the predetermined maximum variation threshold value Vₛₑᵤᵢₗ necessarily being reached.

As a variant, step E5 can be initiated when the predetermined maximum variation threshold value Vₛₑᵤᵢₗ is reached, that is, following step E4.

In one embodiment, step E5 of predicting the distance remaining before a predetermined wear level of the monitored tire is reached can be implemented periodically.

The predetermined wear level can for example correspond to a total wear level of the monitored tire.

The distance remaining can be extrapolated using the following formula:

$${Km}_{restant} = Km ( t ) \cdot ( \frac{{V}_{seuil}}{\vert V ( t ) - {V}_{ref} \vert} - 1 )$$

where:
Kmᵣₑₛₜₐₙₜ is the value of the distance remaining until the predetermined wear level is reached,
Km(t) is the value of the current distance traveled.

Alternatively, the distance remaining can be extrapolated using the following formula:

$${Km}_{restant} = Km ( t ) \cdot ( \frac{{V}_{seuil}}{\vert {V}_{filt} ( t ) - {V}_{ref} \vert} - 1 )$$

The monitoring method of an aspect of the invention can be implemented by a second embodiment.

It has been observed that as the tire wears, the value of the variable V monitored using the method of an aspect of the invention increases as an absolute value.

It has also been observed that as the predetermined maximum variation threshold value Vₛₑᵤᵢₗ corresponding to a very advanced or terminal state of wear of the tire is approached, the variations in the monitored variable V(value of the minimum tangential acceleration peak Zₘᵢₙ or value of the maximum tangential acceleration peak Zₘₐₓ) are much more dynamic.

This is reflected in an increase in the speed at which the value of the monitored variable V approaches the predetermined maximum variation threshold value Vₛₑᵤᵢₗ.

These variations are characterized by the derivative of the monitored variable V relative to time.

Unlike in the first embodiment, the second embodiment does not comprise a step of learning a reference value V_{ref} of the variable under consideration (step E11 of the first embodiment) or entering the reference value V_{ref} of the variable under consideration known from charts into the algorithm for implementing the method of an aspect of the invention.

In the execution of the method according to the second embodiment of the invention, step E1 of acquiring measurements of the variables V can be carried out cyclically by taking a plurality of measurements of the monitored variable V over a current cycle.

For example, for an iteration i performed over a predetermined distance window, the monitored variable V is measured periodically on a time basis.

The distance window can for example be equal to 100 kilometers.

The time basis selected can for example be a minute, that is, a measurement is taken every minute.

As a variant, the monitored variable V can be measured periodically, over the aforementioned predetermined distance window, on a distance basis, for example every kilometer.

Given that there is a running-in phase during which certain parameters specific to the vehicle are set up, step E1 can be initiated after a predetermined number of kilometers has been traveled by the tire to be monitored.

Step E2 of processing the measurements of the acquired variables deduces a mean value of the monitored variables V_{moy}_{ᵢ} on iteration i and a mean value of the monitored variables V_{moy}_{₋₁} on iteration i-1.

Step E2 of processing the measurements of the acquired variables then calculates the derivative in time of the mean values of the acquired variables V_{moy}_{ᵢ} and V_{moy}_{ᵢ₋₁} for each iteration i and i-1.

During step E3, the values

$$\frac{d}{dt} {V}_{{moy}_{i}}$$

and

$$\frac{d}{dt} {V}_{{moy}_{i - 1}} ,$$

obtained during the processing step E2, are compared to a predetermined threshold value Vₛₑᵤᵢₗ_{₂}.

If

$$\vert \frac{d}{dt} {V}_{{moy}_{i}} - \frac{d}{dt} {V}_{{moy}_{i - 1}} \vert > {V}_{{seuil}_{2}} ,$$

then a tire wear warning is generated (step E4) and transmitted by radiofrequency.

According to one variant embodiment, step E2 of processing the measurements of the variables calculates a derivative in time of the mean values of the acquired variables V_{moy}_{ᵢ} on iteration i and of the mean values of the acquired variables V_{moy}_{ᵢ₋ₖ} on iteration i-k, where k>1.

The tire wear warning can thus be generated (step E4) not by comparison between iterations i and i-1 but by comparison between iterations i and i-2, i-3, etc.

Using this second embodiment, the significant variations in the monitored variable V are detected, which makes it possible to deduce that the tire has exceeded its maximum wear level and therefore that the tire is close to the end of its life.

Of course, aspects of the present invention are not limited solely to the embodiments of this method for monitoring the wear of a motor vehicle tire and of this tire pressure monitoring module for implementing said method, which are described above by way of illustrative example only, and it encompasses all variants involving technical equivalents of the means described.

1. A method for monitoring the wear of a motor vehicle tire, implemented by a tire pressure monitoring module mounted in said tire to be monitored, said module comprising a pressure sensor and a tangential accelerometer, said method comprising:
acquiring, from a tangential acceleration signal of said tire pressure monitoring module, measurements of at least one variable (V) in the group comprising a maximum tangential acceleration peak (Zₘₐₓ) and a minimum tangential acceleration peak (Zₘᵢₙ),
performing processing of said measurements of said at least one acquired variable (V),
comparing said processed measurements to a predetermined maximum variation threshold value (Vₛₑᵤᵢₗii), and
transmitting a warning when said predetermined maximum variation threshold value (Vₛₑᵤᵢₗ) is reached.

2. The monitoring method as claimed in claim 1, wherein said acquisition step comprises a sub-step of learning initial conditions aiming to determine a reference value (V_{ref}) of said at least one variable (V).

3. The monitoring method as claimed in claim 2, wherein said reference value (V_{ref}) of said at least one variable (V) is equal to the mean of the values of said at least one variable (V) measured over a predetermined number of kilometers traveled by the monitored tire.

4. The monitoring method as claimed in claim 2, wherein said acquisition step comprises a sub-step subsequent to said sub-step of learning initial conditions and comprising the acquisition of measurements of instantaneous variables (V(t)) or the acquisition of a mean value (V_{filt}(t)) equal to the mean of the values of consecutive measurements of said at least one variable (V) over a predetermined number of kilometers traveled by the monitored tire.

5. The monitoring method as claimed in claim 4, wherein said step of processing said measurements of said at least one variable (V) acquired during the acquisition step is carried out by applying an identity function on the basis of which a value is calculated that is equal to:
the difference, as an absolute value, between one of said instantaneous variables V(t) and said reference value (V_{ref}), or
the difference, as an absolute value, between said mean value (V_{filt}(t)) and said reference value (V_{ref}).

6. The monitoring method as claimed in claim 5, further comprising a step aiming to predict the distance remaining before a predetermined wear level of the monitored tire is reached.

7. The monitoring method as claimed in claim 6, wherein said step of aiming to predict the distance remaining before a predetermined wear level of the monitored tire is reached is implemented following the warning transmission step.

8. The monitoring method as claimed in claim 6, wherein said step aiming to predict the distance remaining before a predetermined wear level of the monitored tire is reached is implemented before the warning transmission step is reached.

9. The monitoring method as claimed in claim 1, wherein said acquisition step is carried out by periodically measuring said at least one variable (V) for an iteration i and for an iteration i-k, k>0, each of said iterations being carried out on a predetermined distance window.

10. The monitoring method as claimed in claim 9, wherein said processing step deduces, from the measurements acquired during the acquisition step:
a mean value of said at least one variable (V_{moy}_{ᵢ}) monitored on iteration i, representing the mean of the measurements of said at least one variable (V) for an iteration i, and
a mean value of said variable (V_{moy}_{ᵢ₋ₖ}), k>0, representing the mean of the measurements of said at least one variable (V) for an iteration i-k.

11. The monitoring method as claimed in claim 10, wherein said processing step is carried out by applying a derivative function on the basis of which a derivative value of the mean values of said at least one variable (V) is calculated that is equal to the difference, as an absolute value, between the derivative relative to time of the mean value of said at least one variable (V_{moy}_{ᵢ}) on iteration i and the derivative relative to time of the mean value of said at least one variable (V_{moy}_{ᵢ₋ₖ}) on iteration i-k, k>0.

12. The monitoring method as claimed in claim 9, wherein said acquisition step is initiated after a predetermined number of kilometers has been traveled by said tire to be monitored.

13. The monitoring method as claimed in claim 1, wherein said at least one variable (V) is a compensated value.

14. A tire pressure monitoring module, comprising hardware and/or software means for implementing the method as claimed in claim 1, wherein said hardware and/or software means are implemented in an integrated circuit.
